(19) United States
(12) Patent Application Publication
(10) Pub. No.: US 2025/0354577 A1
(43) Pub. Date: Nov. 20, 2025

(54) VERSATILE FASTENER

(71) Applicant: ESSENCE METHOD REFINE CO., LTD., TAINAN CITY (TW)

(72) Inventor: LING-FANG CHEN, TAINAN CITY (TW)

(21) Appl. No.: 18/667,127

(22) Filed: May 17, 2024

(51) Int. Cl. F16B 25/00

(52) U.S. Cl. CPC F16B 25/0057; F16B 25/0052

(57) ABSTRACT

A versatile fastener includes a head, a shank, and thread convolutions including a first plurality of thread convolutions, a second plurality of thread convolutions, and a third plurality of thread convolutions. The shank is divided into a plurality of regions according to the pluralities of thread convolutions. Respective upper flanks of the thread convolutions each include an upper connecting section and an upper extension section, and respective lower flanks thereof each include a lower connecting section and a lower extension section, thereby forming three dual-section flank structures. The thread convolutions in at least two regions differ in their respective included angles defined with respect to a baseline which passes through a crest. Accordingly, the dual-section flank structures provide sufficient supporting forces while drilling, augment the cutting efficiency, and attain a stable fastening effect. The fastener is adapted to workpieces made of different materials for multiple applications.

### BACKGROUND OF THE INVENTION

### 1. Field of the Invention

This invention relates to a screw fastener and relates particularly to a versatile fastener capable of being drilled into different kinds of workpieces.

### 2. Description of the Related Art

Referring to FIG. 1, a conventional screw 1 includes a shank 11, a head 12 connected to the shank 11, and threads 13 spiraling around the shank 11. The shank 11 tapers to form a tip 14. In operation, the head 12 is rotated to drill the threads 13 into a workpiece such as wood (not shown), thereby completing a screwing operation. However, the shapes of the threads 13 are approximately the same, so the cutting effect is limited, and wood fibers are not efficiently severed. This situation not only causes larger resistance against the screwing operation but also causes chips generated by cutting to be improperly accumulated. The excessive accumulation of the chips also exerts undue pressure on the workpiece, so the workpiece cracks easily. In terms of the pull-out resistance whereby the screw 1 is not easily pulled out of the workpiece, the threads 13 are each usually provided with the lesser thickness and become thinner, thereby increasing the area of the threads 13 engaged with the workpiece. However, the lesser thickness reduces the strength of the threads 13, which is unfavorable to the screwing operation. For example, slight pressure exerted on the screw 1 breaks the threads 13 easily while drilling, so the threads 13 may be chipped or snapped in two under the pressure. In this regard, the drilling efficiency of the screw 1 is decreased, and even the screw 1 is unable to be drilled into the workpiece. Accordingly, the practical applications of the screw 1 in drilling into the workpieces are restricted. Thus, the screw 1 still needs to be improved.

### SUMMARY OF THE INVENTION

An object of this invention is to provide a versatile fastener capable of providing sufficient supporting forces while drilling and also attaining a preferable cutting sufficiency and a stable fastening effect.

Another object of this invention is to provide a versatile fastener capable of being drilled into workpieces made of different materials for a wide use.

A versatile fastener of this invention is as defined in claim 1 and includes a head, a shank extending outwards from the head and defining a central axis, and a plurality of thread convolutions spirally disposed around an outer periphery of the shank and including a first plurality of thread convolutions, a second plurality of thread convolutions, and a third plurality of thread convolutions. The shank includes a drill portion opposite to the head. The outer periphery of the shank is divided into a plurality of regions according to spiral convolutions of these three pluralities of thread convolutions. Each thread convolution includes an upper flank facing toward the head, a lower flank opposite to the upper flank, and a crest defined along a junction of the upper flank and the lower flank. The thread convolution also defines a baseline passing through the crest. The baseline is perpendicular to the central axis. The upper flank includes an upper connecting section joined to the outer periphery of the shank, a first upper included angle defined between the upper connecting section and the baseline, an upper extension section connected to the upper connecting section and extended to the crest, and a second upper included angle defined between the upper extension section and the baseline. The lower flank includes a lower connecting section joined to the outer periphery of the shank, a first lower included angle defined between the lower connecting section and the baseline, a lower extension section connected to the lower connecting section and extended to the crest, and a second lower included angle defined between the lower extension section and the baseline. The sum of the first upper included angle and the first lower included angle differs from the sum of the second upper included angle and the second lower included angle, so the first plurality of thread convolutions, the second plurality of thread convolutions, and the third plurality of thread convolutions are in the form of a first dual-section flank structure, a second dual-section flank structure, and a third dual-section flank structure, respectively. Furthermore, respective first upper included angles of the thread convolutions located in at least two regions are different from each other. Respective first lower included angles of the thread convolutions located in at least two regions are different from each other. Respective second upper included angles of the thread convolutions located in at least two regions are different from each other. Respective second lower included angles of the thread convolutions located in at least two regions are different from each other. Accordingly, while winding around the outer periphery of the shank, the first plurality of thread convolutions, the second plurality of thread convolutions, and the third plurality of thread convolutions have respective thread shapes in different regions.

In accordance with the above arrangement, these three dual-section flank structures cooperate closely with respective thread shapes of the flank structures formed by the difference in the first upper included angle, the difference in the first lower included angle, the difference in the second upper included angle, and the difference in the second lower included angle. This cooperation allows the fastener to be drilled into different kinds of workpieces, especially into workpieces made of harder materials, and also provides the fastener with efficient supporting forces while drilling, so the drill portion and the shank are quickly drilled into the workpiece. Respective thread shapes arranged in respective regions also allow the thread convolutions to cut different drilled workpieces efficiently according to material properties of the drilled workpieces. Therefore, the cutting efficiency is increased, and the drilling resistance is decreased. The vibration resistance and the pull-out resistance can also be augmented to attain a stable fastening effect and prevent the fastener from being easily pulled out. The fastener does not restrict itself to being drilled into a workpiece made of one material, so the fastener has a broad range of applications.

Preferably, a thread unit is defined when the thread convolutions are spirally disposed around the outer periphery of the shank in a single and continuous convoluting manner. In one preferred embodiment, a maximum thread diameter is defined by the thread unit. An outer diameter is defined by the outer periphery of the shank. The value of the maximum thread diameter is at least 1.6 times the value of the outer diameter.

Preferably, in one preferred embodiment, respective first upper included angles of the thread convolutions located in all regions are different from each other. Respective first lower included angles of the thread convolutions located in all regions are different from each other. Respective second upper included angles of the thread convolutions located in all regions are different from each other. Respective second lower included angles of the thread convolutions located in all regions are different from each other. Accordingly, while winding around the outer periphery of the shank, the first plurality of thread convolutions, the second plurality of thread convolutions, and the third plurality of thread convolutions have different thread shapes in different regions.

Preferably, the first upper included angle is equal to or different from the first lower included angle in any one region.

Preferably, the second upper included angle is equal to or different from the second lower included angle in any one region.

Preferably, in one preferred embodiment, the outer periphery of the shank has a non-circular shape.

Preferably, in one preferred embodiment, each thread convolution forms a first upper junction, a second upper junction, a first lower junction, and a second lower junction. The first upper junction is a place where the upper connecting section and the outer periphery of the shank meet. The second upper junction is a place where the upper connecting section and the upper extension section meet. The first lower junction is a place where the lower connecting section and the outer periphery of the shank meet. The second lower junction is a place where the lower connecting section and the lower extension section meet. A first reference line is defined between the first upper junction and the first lower junction and perpendicular to the baseline. A second reference line is defined by passing through the second upper junction and the second lower junction and perpendicular to the baseline. A thread height is defined as a vertical distance from the first reference line to the crest, and a first height is defined as a vertical distance from the first reference line to the second reference line. The value of the first height is ⅓˜½ times the value of the thread height.

Preferably, in one preferred embodiment, the first angle ranges from 40 degrees to 60 degrees, and the second angle ranges from 25 degrees to 50 degrees.

Preferably, in one preferred embodiment, the first angle exceeds 90 degrees, such as from 100 degrees to 110 degrees. In this regard, it is possible that the upper connecting section or the lower connecting section has a non-circular shape.

Preferably, at least two thread convolutions of the thread convolutions are spirally disposed around the drill portion to facilitate an initial cutting effect and attain the effect of engaging with the workpiece.

Preferably, the outer periphery of the shank is exposed to an outside between axially spaced-apart adjacent thread convolutions. Each exposed segment of the outer periphery includes a first transition section connected to the upper connecting section and a second transition section connected to the lower connecting section. The first transition section has an arcuate surface, and the second transition section has an arcuate surface.

### BRIEF DESCRIPTION OF THE DRAWINGS

This invention is more particularly described, by way of example, with reference to the accompanying drawings.

FIG. 1 is a schematic view showing a conventional screw;

FIG. 2 is a schematic view showing a first preferred embodiment of this invention;

FIG. 3 is a cross-sectional view of the first preferred embodiment;

FIG. 3A is an enlarged view showing an encircled portion 3A of FIG. 3;

FIG. 3B is an enlarged view showing an encircled portion 3B of FIG. 3;

FIG. 3C is an enlarged view showing an encircled portion 3C of FIG. 3;

FIG. 4 is a schematic view showing one variant of a second preferred embodiment of this invention;

FIG. 4A is an enlarged view showing an encircled portion 4A of FIG. 4;

FIG. 4B is a partially enlarged view showing another variant of the second preferred embodiment;

FIG. 5 is a cross-sectional view showing a third preferred embodiment of this invention;

FIG. 6 is a schematic view showing one variant of a fourth preferred embodiment of this invention;

FIG. 7 is a schematic view showing another variant of the fourth preferred embodiment;

FIG. 8A is a cross-sectional view taken along 8A-8A line of FIG. 6;

FIG. 8B is a cross-sectional view taken along 8B-8B line of FIG. 7;

FIG. 9 is a schematic view showing a fifth preferred embodiment of this invention;

FIG. 10 is a cross-sectional view showing the fifth preferred embodiment;

FIG. 10A is an enlarged view showing an encircled portion 10A of FIG. 10;

FIG. 10B is an enlarged view showing an encircled portion 10B of FIG. 10;

FIG. 10C is an enlarged view showing an encircled portion 10C of FIG. 10;

FIG. 11 is a schematic view showing a sixth preferred embodiment of this invention;

FIG. 12 is a cross-sectional view showing the sixth preferred embodiment;

FIG. 12A is an enlarged view showing an encircled portion 12A of FIG. 12;

FIG. 12B is an enlarged view showing an encircled portion 12B of FIG. 12;

FIG. 12C is an enlarged view showing an encircled portion 12C of FIG. 12;

FIG. 13 is a schematic view showing one variant of a seventh preferred embodiment of this invention;

FIG. 14 is a schematic view showing another variant of the seventh preferred embodiment;

FIG. 15 is a schematic view showing one variant of an eighth preferred embodiment of this invention;

FIG. 16 is a schematic view showing another variant of the eighth preferred embodiment;

FIG. 17 is a brief view showing the shapes of elements of FIG. 13;

FIG. 18 is a brief view showing the shapes of elements of FIG. 14;

FIG. 19 is a brief view showing the shapes of elements of FIG. 15;

FIG. 20 is a brief view showing the shapes of elements of FIG. 16;

FIG. 21 is a schematic view showing one variant of a ninth preferred embodiment of this invention;

FIG. 21A is an enlarged view showing an encircled portion 21A of FIG. 21;

FIG. 22 is a schematic view showing another variant of the ninth preferred embodiment; and

FIG. 22A is an enlarged view showing an encircled portion 22A of FIG. 22.

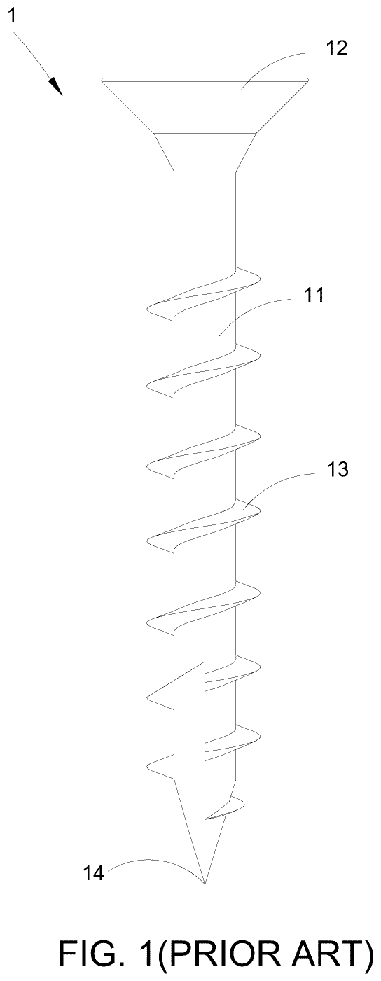

### DETAILED DESCRIPTION OF THE PREFERRED EMBODIMENTS

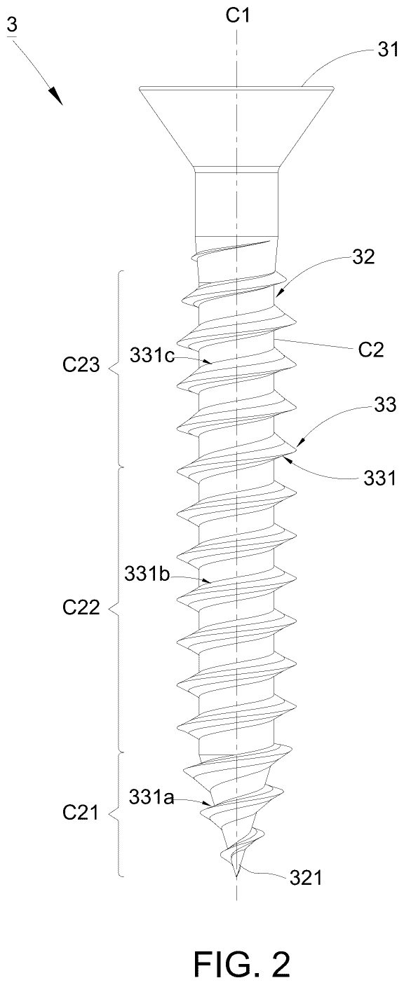

Referring to FIG. 2, a first preferred embodiment of the versatile fastener 3 is shown. The fastener 3 includes a head 31, a shank 32 extending outwards from the head 31, and a plurality of thread convolutions 331 spirally disposed around the shank 32. An outer periphery C2 of the shank 32 is axially extended, so a central axis C1 is defined. The outer periphery C2 includes a drill portion 321 formed in opposing relationship to the head 31. The drill portion 321 can be in any forms. For example, FIG. 2 shows that the outer periphery C2 of the shank 32 tapers to form a sharp tip, and this tapering form serves as the drill portion 321.

The thread convolutions 331 can be spirally disposed by winding around the outer periphery C2 continuously, thereby defining a thread unit 33 in a single and continuous winding manner. In other words, the thread unit 33 is a single-convoluted arrangement around the shank 32 and consists of the plurality of spiral thread convolutions 331, which include a first plurality of thread convolutions 331a (hereinafter referred to intermittently, for simplicity, as “first threads” (for plural) or a “first thread” (for singular)), a second plurality of thread convolutions 331b (hereinafter referred to intermittently, for simplicity, as “second threads” (for plural) or a “second thread” (for singular)), and a third plurality of thread convolutions 331c (hereinafter referred to intermittently, for simplicity, as “third threads” (for plural) or a “third thread” (for singular)). According to the spiral convolutions of the first threads 331a, the second threads 331b, and the third threads 331c, the outer periphery C2 of the shank 32 is divided into a plurality of regions, which, for example, include a first region C21, a second region C22, and a third region C23. The thread convolutions 331 situated in the first regions C21 are defined as the first threads 331a. The thread convolutions 331 situated in the second regions C22 are defined as the second threads 331b. The thread convolutions 331 situated in the third regions C23 are defined as the third threads 331c. Conditions related to respective positions of these three regions C21, C22, C23 and the number of the thread convolutions 331 in each region C21, C22, C23 are not restricted. These conditions are adjustable according to the demand of users or according to the material of the workpiece to be drilled. In the first preferred embodiment, FIG. 2 shows an example illustrating that the second region C22 is situated between the first region C21 and the third region C23, the first region C21 is situated between the tip and the second region C22, and the third region C23 is situated between the second region C22 and the head 31. Furthermore, at least two thread convolutions 331, that is, two or more than two thread convolutions 331, can be spirally disposed around the drill portion 321. Take for example three spirally-disposed first threads 331a formed in the first region C21 when the drill portion 321 is situated in the first region C21.

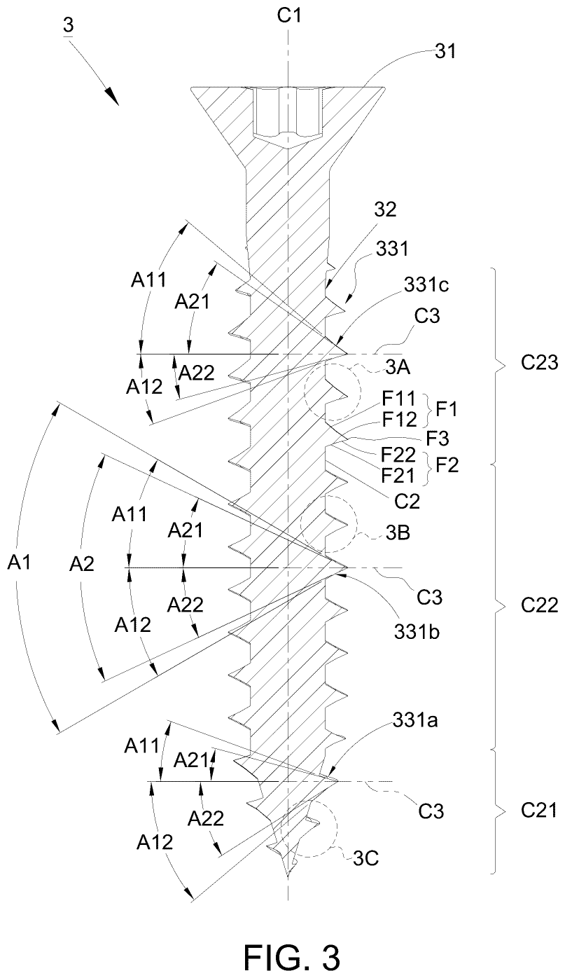

Referring to FIG. 3, each thread convolution 331 includes an upper flank F1, a lower flank F2 opposite to the upper flank F1, and a crest F3 defined along a junction of the upper flank F1 and the lower flank F2. The upper flank F1 faces toward the head 31. The lower flank F2 faces toward the drill portion 321. A baseline C3 passes through the crest F3 and is perpendicular to the central axis C1. The upper flank F1 includes an upper connecting section F11 and an upper extension section F12. The upper connecting section F11 is joined to the outer periphery C2 of the shank 32 and extended by a length. The upper extension section F12 is connected to the upper connecting section F1 and extended to the crest F3. The lower flank F2 includes a lower connecting section F21 and a lower extension section F22. The lower connecting section F21 is joined to the outer periphery C2 of the shank 32 and extended by a length. The lower extension section F22 is connected to the lower connecting section F21 and extended to the crest F3. The thread convolution 331 further defines a first angle A1 and a second angle A2. The first angle A1 includes a first upper included angle A11 defined between the upper connecting section F11 and the baseline C3 and a first lower included angle A12 defined between the lower connecting section F21 and the baseline C3. In brief, the sum of the first upper included angle A11 and the first lower included angle A12 is defined as the first angle A1. The second angle A2 includes a second upper included angle A21 defined between the upper extension section F12 and the baseline C3 and a second lower included angle A22 defined between the lower extension section F22 and the baseline C3. In brief, the sum of the second upper included angle A21 and the second lower included angle A22 is defined as the second angle A2. The first angle A1 differs from the second angle A2, so a dual-section flank structure is generated. For the sake of conciseness, the first angle A1 and the second angle A2 are only indicated on the second thread 331b in FIG. 3.

The first angle A1 can be greater than the second angle A2. Preferably, the first angle A1 ranges from 40 degrees to 60 degrees, and the second angle A2 ranges from 25 degrees to 50 degrees. The values of the first angle A1 and the second angle A2 are adjustable according to workpieces made of different materials. For example, the first angle A1 ranges from 40 degrees to 60 degrees, and the second angle A2 ranges from 25 degrees to 39 degrees when workpieces to be drilled are made of soft materials, such as soft woods, plastic, and calcium silicate boards. The first angle A1 is 60 degrees, and the second angle A2 ranges from 40 degrees to 50 degrees when workpieces to be drilled are made of hard materials, such as hard woods, concrete, and iron boards. Accordingly, the thread convolutions 331 in the first region C21, namely first threads 331a, are each in the form of a first dual-section flank structure. The thread convolutions 331 in the second region C22, namely the second threads 331b, are each in the form of a second dual-section flank structure. The thread convolutions 331 in the third region C23, namely the third threads 331c, are each in the form of a third dual-section flank structure.

Regarding the included angles applied to these three dual-section flank structures, it is required that respective first upper included angles A11 of the thread convolutions 331 located in at least two regions of the regions are different from each other, respective first lower included angles A12 of the thread convolutions 331 located in at least two regions of the regions are different from each other, respective second upper included angles A21 of the thread convolutions 331 located in at least two regions of the regions are different from each other, and respective second lower included angles A22 of the thread convolutions 331 located in at least two regions of the regions are different from each other. According to the above requirements applied to these three regions C21, C22, C23 shown in the first preferred embodiment, if two selected regions have different included angles, and the included angle of the remaining region other than the selected regions can be equal to or different from the included angle of either one of the selected regions. For instance, when the first upper included angle A11 in the first region C21 is different from the first upper included angle A11 in the second region C22, the first upper included angle A11 in the third region C21 can be equal to or different from the first upper included angle A11 in either the first region C21 or the second region C22. In other words, if the second region C22 and the third region C23 have the same first upper included angles A11, the first upper included angle A11 in the first region C21 is different from the first upper included angle A11 in both of the second region C22 and the third region C23. The same rule is also applied to other included angles, namely the first lower included angle A12, the second upper included angle A21, and the second lower included angle A22, and herein is not repeated. Because of the above included angles, the first dual-section flank structure, the second dual-section flank structure, and the third dual-section flank structure have respective thread shapes while winding the first threads 331a, the second threads 331b, and the third threads 331c around the shank 32 spirally.

In the first preferred embodiment, FIG. 3 shows that respective first upper included angles A11 of the thread convolutions 331 located in all regions C21, C22, C23 are different from each other, respective first lower included angles A12 of the thread convolutions 331 located in all regions C21, C22, C23 are different from each other, respective second upper included angles A21 of the thread convolutions 331 located in all regions C21, C22, C23 are different from each other, and respective second lower included angles A22 of the thread convolutions 331 located in all regions C21, C22, C23 are different from each other. Therefore, the thread unit 33 is formed by a single and continuous convolution which includes different thread shapes arranged in different regions, thereby executing a drilling action of the fastener 3 which is described below.

Regarding the aforementioned thread shape, the thread shape is adjustable according to the demand of users or according to the material of the workpiece to be drilled. The first upper included angle A11 is equal to or different from the first lower included angle A12 in any one region of the regions. The second upper included angle A21 is equal to or different from the second lower included angle A22 in any one region of the regions. Take for example the thread shapes adopted in FIG. 3 which represents the first preferred embodiment, wherein in the first region C21, the first lower included angle A12 is greater than the first upper included angle A11, and the second lower included angle A22 is greater than the second upper included angle A21, so the first thread 331a has an upward thread shape (see FIG. 3C in which the thread 331a tends to point upwardly). In the second region C22, the first lower included angle A12 is equal to the first upper included angle A11, and the second lower included angle A22 is equal to the second upper included angle A21, so the second thread 331b has a symmetric thread shape (see FIG. 3B). In the third region C23, the first lower included angle A12 is smaller than the first upper included angle A11, and the second lower included angle A22 is smaller than the second upper included angle A21, so the third thread 331c has a downward thread shape (see FIG. 3A in which the thread 331c tends to point downwardly). The operation of the fastener 3 is described according to the above thread shapes distributed in different regions.

The operation of this invention is described with the aid of FIG. 2 and FIG. 3. The fastener 3 is adapted to be drilled into a workpiece made of iron, hard wood, soft wood, cement, calcium silicate, plastic, etc. Therefore, the fastener 3 is adapted to different kinds of workpieces for multipurpose applications. Herein, take for example the workpiece made of cement (not shown). In use, the cement workpiece is predrilled with a tool (not shown) to form a drilled hole, and the drill portion 321 enters the drilled hole while rotating the head 31 to start a screwing operation. At the beginning of the screwing operation, the cement workpiece is initially cut by the first threads 331a in the first region C21. The lower connecting section F21 of each first thread 331a has a thicker configuration because of the upward thread shape, which causes the lower flank F2 to provide a larger area. Meanwhile, the first upper included angle A11 associated with the upper connecting section F11 functions to support the lower connecting section F21. Accordingly, the first dual-section flank structure of the first threads 331a breaks and cuts a wall of the drilled hole efficiently and also enlarges the drilled hole for attaining a reaming effect. These actions increase cutting forces that the thread convolutions 331 as a whole exert on the cement workpiece. Therefore, the thread convolutions 331 as a whole are not easily broken to prevent the occurrence of the chipping problem and the snapping problems, and the thread convolutions 331 also keeps a vertical drilling motion. In this case, the wall of the drilled hole is efficiently broken, and the downward pulling force is concurrently generated for cutting quickly, thereby drilling the shank 32 into the cement workpiece stably and attaining a speedy drilling effect.

The initial cutting action of the first threads 331a allows the shank 32 to be continuously drilled into the cement workpiece. During the drilling action, cement chips generated by the cutting action are gradually moved from the first region C21 to the second region C22 and stably moved toward the third region C23 by following the spiral convolution of the symmetric thread shape of the second dual-section flank structure of the second threads 331b. Because the third threads 331c located in the third region C23 has a downward thread shape, the upper flank F1 of the third dual-section flank structure has a larger area capable of providing sufficient supporting force. Accordingly, the third threads 331c bear lesser resistance while cutting the cement workpiece so that the cement workpiece is subjected to an efficient cutting action, thereby reducing the drilling resistance and avoiding the undue pressure exerted on the third threads 331c and the shank 32. Accordingly, the third threads 331c are not chipped or broken, and the shank 32 is not snapped in two. During the cutting action of the third threads 331c, some cement chips move toward the head 31 by following the spiral convolution of the third threads 331c for attaining the removal of chips. Remaining cement chips are pressed downwardly by the downward thread shape and left in the drilled hole to attain the accommodation of chips and attain an efficient engagement between the fastener 3 and the cement workpiece for fastening, thereby increasing the vibration resistance and augmenting the pull-out resistance. The increased vibration resistance allows the fastener 3 to withstand external vibration because the fastener 3 has sufficient strength. The augmented pull-out resistance prevents the fastener 3 from being easily pulled out of the workpiece. On the whole, the dual-section flank structures with respective thread shapes are spirally distributed in different regions of the shank 32, so the fastener 3 as a whole cuts the workpiece quickly to augment the drilling efficiency, and enough chips are properly accommodated between the workpiece and the fastener 3 to attain a stable fastening effect. The fastener 3 does not restrict itself to being drilled into a workpiece made of one material, so the fastener 3 has a broad range of applications.

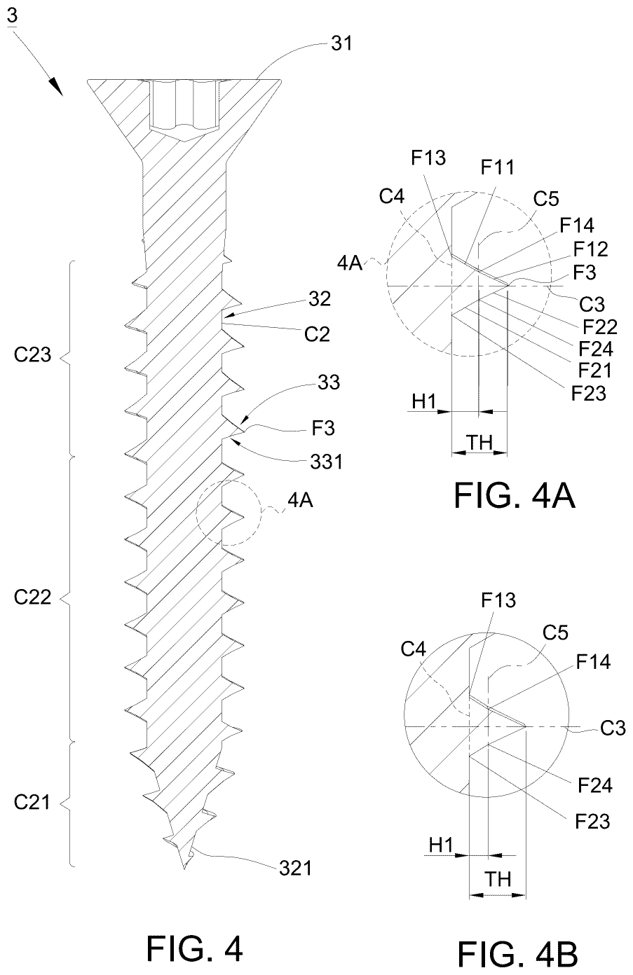

Referring to FIG. 4, a second preferred embodiment of the versatile fastener 3 is shown. Elements of the second preferred embodiment are the same as those of the first preferred embodiment and herein are not repeated. Further referring to FIG. 4 and FIG. 4A, a first upper junction F13, a second upper junction F14, a first lower junction F23, and a second lower junction F24 are respectively formed. A thread height TH and a first height H1 are respectively defined. Specifically, the first upper junction F13 is a place where the upper connecting section F11 and the outer periphery C2 of the shank 32 meet. The second upper junction F14 is a place where the upper connecting section F11 and the upper extension section F12 meet. The first lower junction F23 is a place where the lower connecting section F21 and the outer periphery C2 of the shank 32 meet. The second lower junction F24 is a place where the lower connecting section F21 and the lower extension section F22 meet. Regarding any one thread convolution 331, a first reference line C4 is defined between the first upper junction F13 and the first lower junction F23. A second reference line C5 passes through the second upper junction F14 and the second lower junction F24. The first reference line C4 and the second reference line C5 are perpendicular to the baseline C3, respectively. In this regard, the thread height TH, a vertical distance with respect to the baseline C3, is defined from the first reference line C4 and the crest F3. The first height H1, a vertical distance with respect to the baseline C3, is defined from the first reference line C4 to the second reference line C5. Preferably, the value of the first height H1 is ⅓˜½ times the value of the thread height TH and is adjustable according to the material of the workpiece to be drilled.

In the second preferred embodiment, FIG. 4A shows that the value of the first height H1 is ½ times the value of the thread height TH. FIG. 4B shows that the value of the first height H1 is ⅓ times the value of the thread height TH. Furthermore, all of the regions, namely the first region C21, the second region C22, and the third region C23, can be of equal first height H1 or different first heights H1. Alternatively, any two regions can be of equal height H1. In FIG. 4A, it is shown that all thread convolutions 331 have the same first height H1, the value of which is ½ times the value of the thread height TH.

The first height H1 decides the extension lengths of the upper connecting section F11 and the lower connecting section F12. For instance, the thread configuration (½ times) of FIG. 4A is thicker than the thread configuration (⅓ times) of FIG. 4B and provides greater supporting strength. Accordingly, the fastener 3 shown in FIG. 4A is adapted to be drilled into a hard workpiece. The hard workpiece is efficiently reamed and cut with the thicker thread configuration during the drilling action, thereby preventing the thread convolutions 331 from being broken. The thread configuration shown in FIG. 4B is adapted to be drilled into a soft workpiece. This thread configuration allows the thread convolutions 331 to be firmly engaged with the soft workpiece so that the engagement force is increased for fastening, and the shank 32 does not loosen easily, thereby increasing the vibration resistance that resists the external vibration and enhancing the pull-out resistance that prevents the fastener 3 from being easily pulled out. Consequently, the fastener 3 as a whole increases the drilling efficiency and attains a stable fastening effect. The fastener 3 can also be drilled into workpieces made of different materials to attain a wide use.

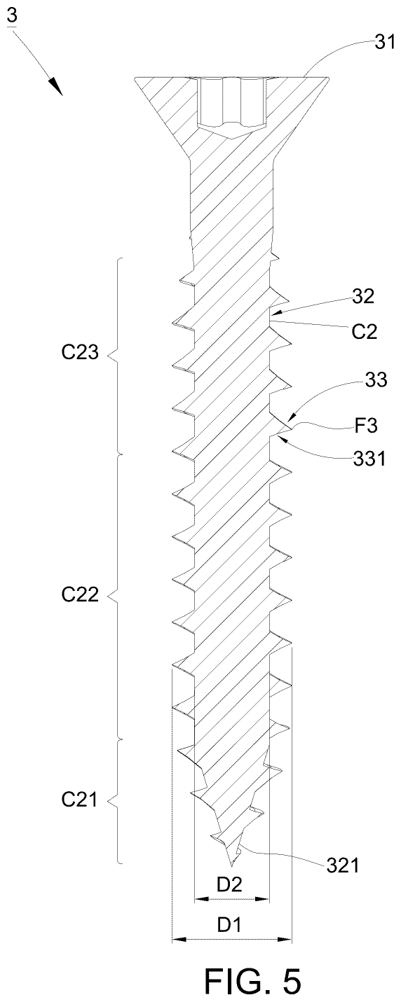

Referring to FIG. 5, a third preferred embodiment of the versatile fastener 3 is shown. Elements and operations of the third preferred embodiment are the same as those of the first preferred embodiment and herein are not repeated. This preferred embodiment is characterised in that an outer diameter D2 is defined by the outer periphery C2 of the shank 32. A maximum thread diameter D1 is defined by the thread unit 33. The maximum thread diameter D1 can be a straight line between two points lying on the crest F3 of the thread convolutions 331 spiraling between the drill portion 321 and the head 31. The value of the maximum thread diameter D1 is at least 1.6 times the value of the outer diameter D2, that is, 1.6 times or more than 1.6 times. Accordingly, the fastener 3 can be drilled into some specific workpieces, such as a soft wood, a calcium silicate board, and a plastic board. The larger thread diameter D1 enlarges the area of the thread convolutions 331 which is in contact with the workpiece, so the thread convolutions 331 are engaged with the workpiece with larger forces. Meanwhile, the thread convolutions 331 also pressurize the workpiece so that the fastener 3 is fastened to the workpiece more firmly, thereby increasing the pull-out resistance which prevents the fastener 3 from being easily pulled out. In other words, the fastener 3 does not loosen, so an anti-loosening effect is attained. Consequently, the fastener 3 as a whole increases the drilling efficiency, attains a stable fastening effect, and attains a wide use.

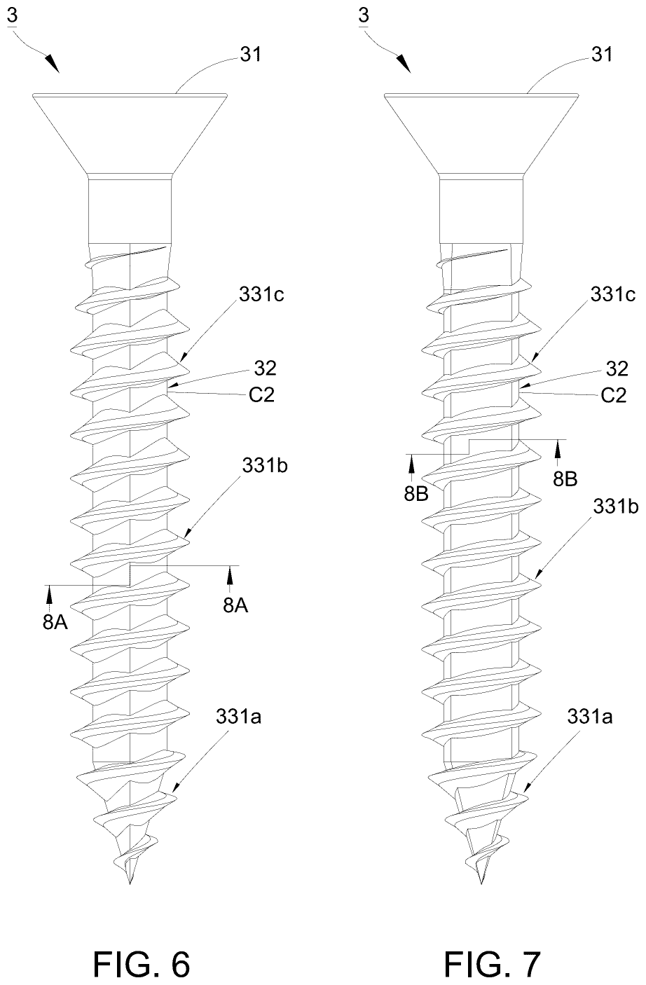

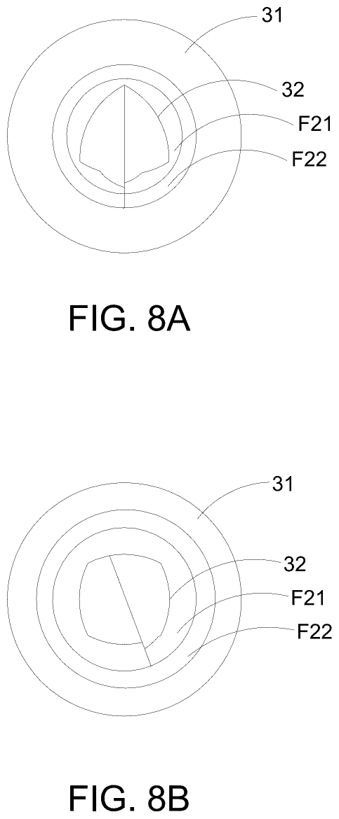

Referring to FIG. 6 and FIG. 7, a fourth preferred embodiment of the versatile fastener 3 is shown. Elements and operations of the fourth preferred embodiment are the same as those of the first preferred embodiment and herein are not repeated. This preferred embodiment is characterised in that the outer periphery C2 of the shank 32 has a non-circular shape, such as a shape with three sides shown in FIG. 6 and FIG. 8A and a shape with four sides shown in FIG. 7 and FIG. 8B. The shape with three sides can be a triangular shape. The shape with four sides can be a quadrilateral shape. Accordingly, when the fastener 3 is drilled into a cement workpiece or other similar workpieces, the shank 32 is allowed to cut the workpiece with multiple cutting points because of the three-sided shape or the four-sided shape. This non-circular shape attains an auxiliary cutting effect. Consequently, respective thread shapes of the first threads 331a, the second threads 331b, and the third threads 331c cooperate with the non-circular shank 31 to cut the workpiece efficiently so that the drilling efficiency is increased.

Generally, cement chips are generated when the cement undergoes the cutting action of the fastener 3. Unlike wood chips, the cement chips are usually unable to be directly forced out of the drilled hole. The non-circular shape allows a space to be properly formed between the shank 32 and the drilled hole of the cement workpiece. An appropriate quantity of cement chips can be accommodated in the space, which prevents the undue accumulation of cement chips from breaking the shank 32 and the thread convolutions 331 and also fastens the fastener 3 to the workpiece more firmly to improve the pull-out resistance. Consequently, the fastener 3 as a whole increases the drilling efficiency, attains a stable fastening effect, and attains a wide use.

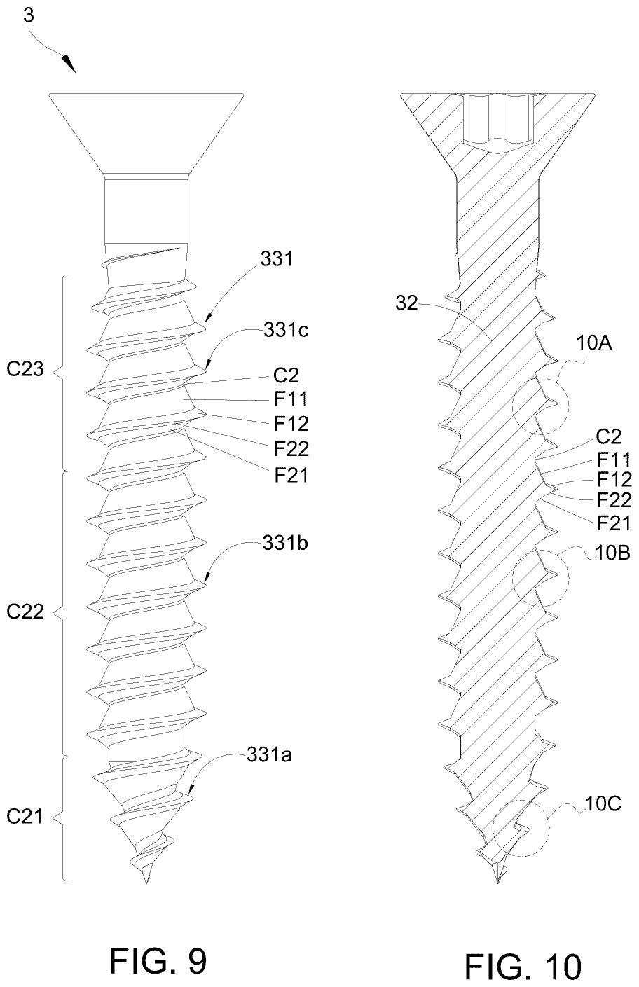

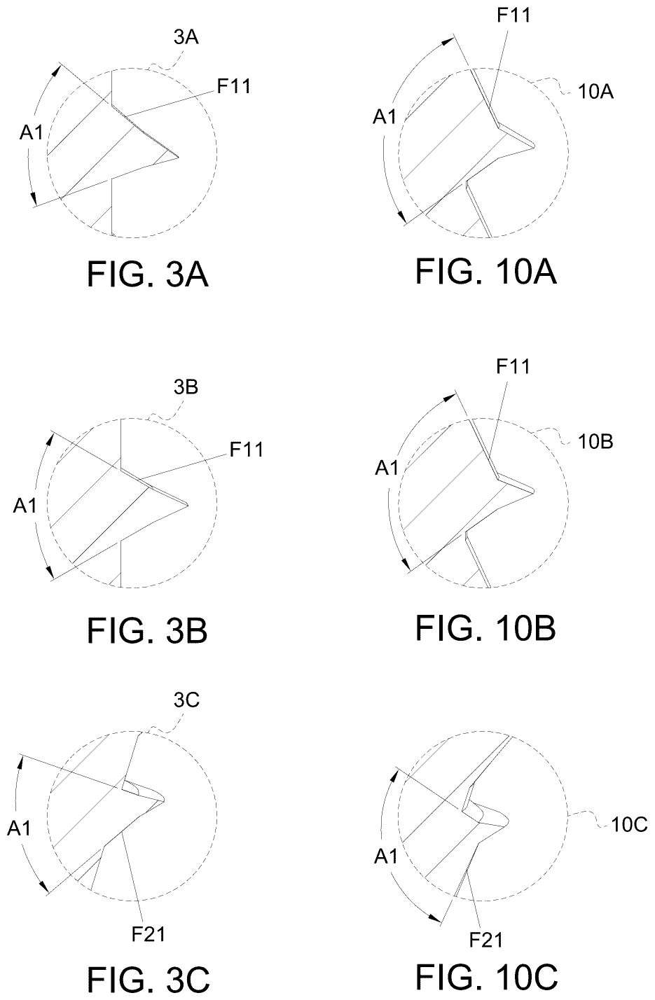

Referring to FIG. 9 and FIG. 10, a fifth preferred embodiment of the versatile fastener 3 includes the elements disclosed in the first preferred embodiment, and the elements herein are not repeated. The fifth preferred embodiment is characterised in that the first angle A1 exceeds 90 degrees, preferably from 100 degrees to 110 degrees. For example, 105 degrees can be an optimum value. Accordingly, choosing the slope degree of the upper connecting section F11 and the slope degree of the lower connecting section F21 depends on the value of the first angle A1. Take for example of the thread shapes of the first preferred embodiment for further discussion. If the first angle A1 is greater than 90 degrees, the upper connecting section F11 has a larger extension area (shown in FIG. 10A and FIG. 10B), or the lower connecting section F21 has a larger extension area (shown in FIG. 10C). By contrast, if the first angle A1 is lower than 90 degrees, the upper connecting section F11 has a smaller extension area (shown in FIG. 3A and FIG. 3B), or the lower connecting section F21 has a smaller extension area (shown in FIG. 3C). According to the above, the upper connecting section F11 shown in FIG. 10A and FIG. 10B is steeper than the upper connecting section F11 shown in FIG. 3A and FIG. 3B in terms of the downward thread shape and the symmetric thread shape of the first preferred embodiment, so each upper connecting sections F11 of FIG. 10A and FIG. 10B is narrow at its upper portion and wide at its lower portion (hereinafter referred to as “trailing slope” representing that the upper connecting section F11 has a narrow top and a wide bottom). The lower connecting section F21 shown in FIG. 10C is steeper than the lower connecting section F21 shown in FIG. 3C in terms of the upward thread shape of the first preferred embodiment, so the lower connecting section F21 of FIG. 10C is wide at its upper portion and narrow at its lower portion (hereinafter referred to as “leading slope” representing that the lower connecting section F21 has a wide top and a narrow bottom).

The trailing slope and leading slope can be arranged according to the demand of users or according to the material of the workpiece to be drilled. For instance, the trailing slope coexists with the leading slope, and the trailing slope and the leading slope are each arranged in any one region of the outer periphery C2 of the shank 32 freely. Alternatively, either the trailing slope or the leading slope is arranged in all regions of the outer periphery C2 of the shank 32. Regarding the fifth preferred embodiment, FIG. 9, for example, shows that when the first region C21, the second region C22, and the third region C23 are defined from the tip of the shank 32 toward the head 31 in sequence, the first threads 331a located in the first region C21 each provide the leading slope, and the second threads 331b located in the second region C22 and the third threads 331c located in the third region C23 each provide the trailing slope, thereby executing a drilling action which is described below.

The fastener 3 can be directly drilled into a workpiece, such as wood, a plastic board, a calcium silicate board, and cement. The fastener 3 may be drilled without forming a hole in advance. Because the workpiece usually has elasticity, the leading slope of the first threads 331a in the first region C21 bores a drilled hole and makes the hole larger for attaining a reaming effect. In the meantime, the lower connecting section F21 generates the downward pulling force so that the shank 32 keeps drilling into the workpiece vertically, and this vertical movement facilitates a quick and smooth drilling action and prevents the workpiece from cracking. The trailing slope of the second threads 331b and the trailing slope of the third threads 331c assist the fastener 3 in engaging with the workpiece so that the shank 32 does not escape from the workpiece to attain an anti-loosening effect whereby the vibration resistance and the pull-out resistance can be augmented. Respective trailing slopes also provide the second threads 331b and the third thread 331c with auxiliary supporting forces and resist the pressure incurred by the drilling action, which increases the compressive strength and the shear strength in both regions C22, C23 and avoids breaking the thread convolutions 331 as a whole and the shank 32. Consequently, the fastener 3 as a whole increases the drilling efficiency and attains a stable fastening effect by cooperating the thread shapes of the thread convolutions in different regions with the leading slope and the trailing slope.

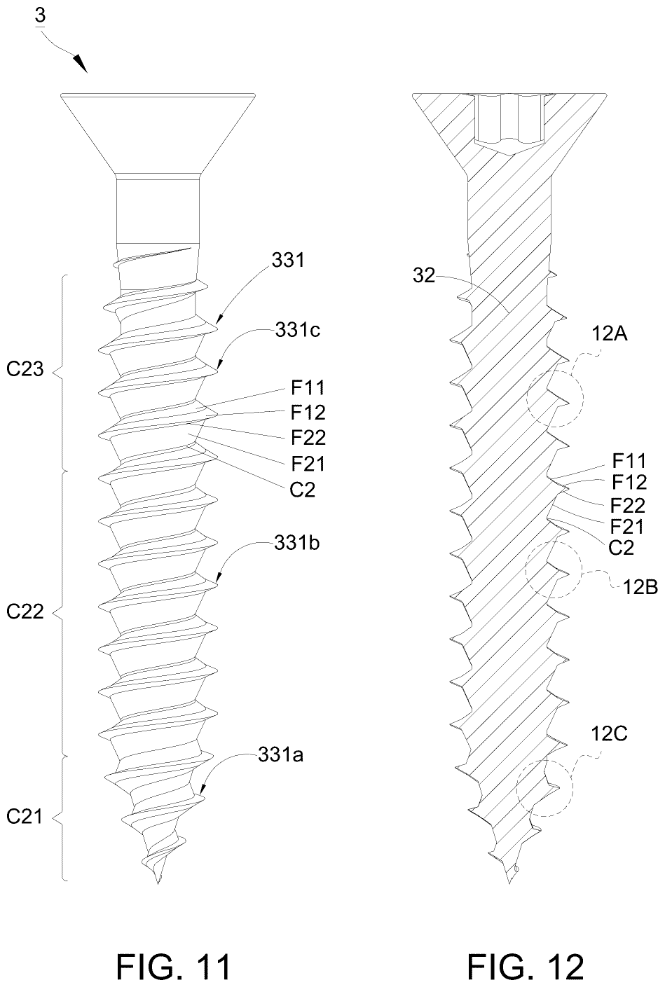

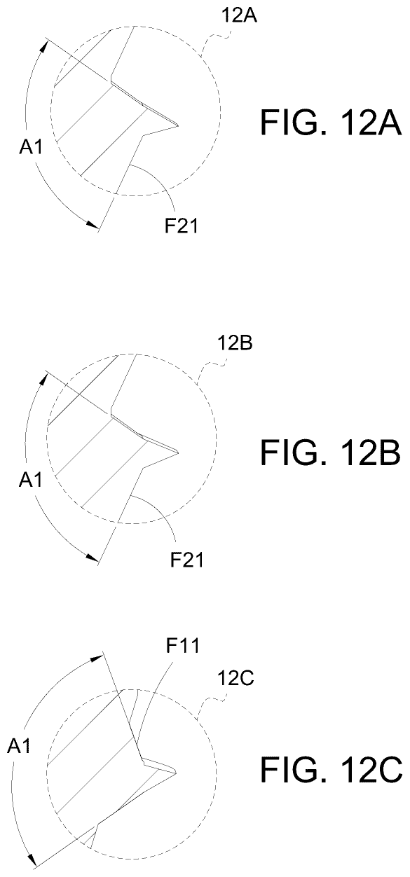

Referring to FIG. 11 and FIG. 12, a sixth preferred embodiment of the versatile fastener 3 is shown. The sixth preferred embodiment is characterised in that FIG. 11, for example, shows that when the first region C21, the second region C22, and the third region C23 are defined from the tip of the shank 32 toward the head 31 in sequence, the first threads 331a located in the first region C21 each provide the trailing slope (see FIG. 12C), and the second threads 331b located in the second region C22 and the third threads 331c located in the third region C23 each provide the leading slope (see FIG. 12B and FIG. 12A). In this case, the fastener 3 can be drilled into a workpiece, such as hard wood, cement, and an iron board. The trailing slope in the first region C21 attains an initial engagement with the workpiece to prevent the shank 32 from loosening. The trailing slope also provides the first threads 331a with an auxiliary supporting force to fight against the pressure, thereby increasing the compressive strength and the shear strength in the first region C21 and preventing the shank 32 and the thread convolutions 331 from being broken. Then, respective leading slopes assist the second region C22 and the third region C23 in implementing a vertical drilling motion. Meanwhile, the second threads 331b and the third threads 331c generate downward pulling forces and ream by enlarging the drilled hole. Thus, the shank 32 is quickly drilled into the workpiece without difficulties. Consequently, the fastener 3 as a whole increases the drilling efficiency and attains a stable fastening effect by cooperating the thread shapes of the thread convolutions in different regions with the trailing slope and the leading slope.

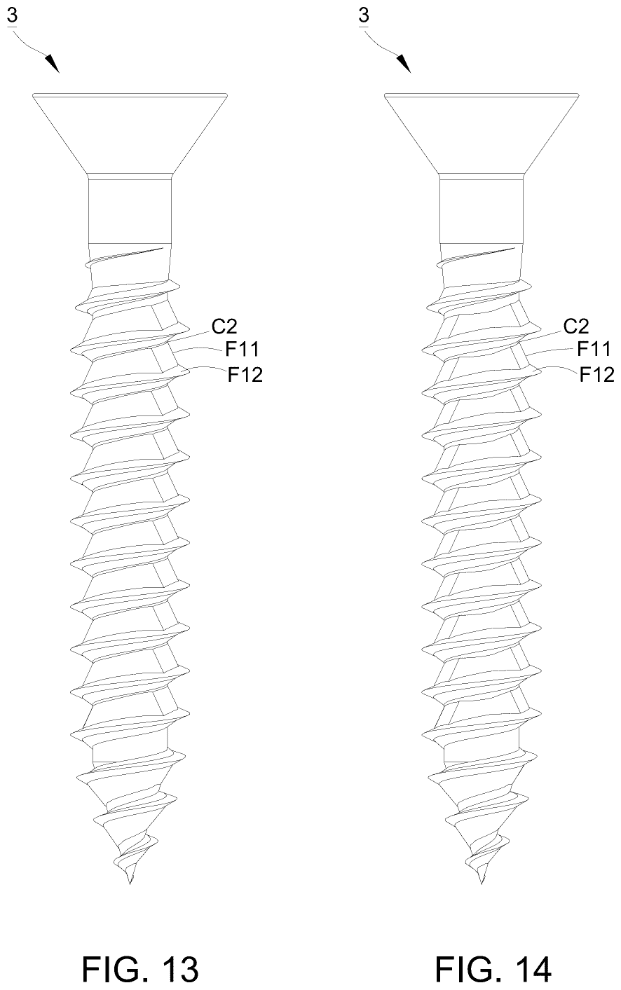

Referring to FIG. 13 and FIG. 14, a seventh preferred embodiment of the versatile fastener 3 is shown. Elements of the seventh preferred embodiment are the same as those of the fifth preferred embodiment. The seventh preferred embodiment is characterised in that the upper connecting section F11 has a non-circular shape, such as a shape with three sides and a shape with four sides. The shape with three sides can be a triangular shape. The shape with four sides can be a quadrilateral shape. Furthermore, the non-circular shape can combine with the structure illustrated by FIG. 9. One combination is shown in FIG. 13 and FIG. 17 wherein the upper connecting section F11 has a three-sided shape. Another combination is shown in FIG. 14 and FIG. 18 wherein the upper connecting section F11 has a four-sided shape. The shapes of the outer periphery C2 of the shank 32 and the upper extension section F12 are not restricted, and herein the circular shape is shown as an example. Accordingly, the non-circular shape allows the thread convolution 331 to cut the workpiece with multiple cutting points, so the drilling efficiency is increased. The non-circular shape also allows an appropriate quantity of workpiece chips to be accommodated between the shank 32 and the workpiece, which causes the fastener 3 to be firmly engaged with the workpiece. In this regard, the pull-out resistance is augmented to prevent the fastener 3 from being easily pulled out. Meanwhile, the strength of the thread configurations of the thread convolutions 331 is maintained because of the geometric design of the three-sided shape or the four-sided shape. Consequently, the fastener 3 as a whole increases the drilling efficiency, attains a stable fastening effect, and attains a wide use.

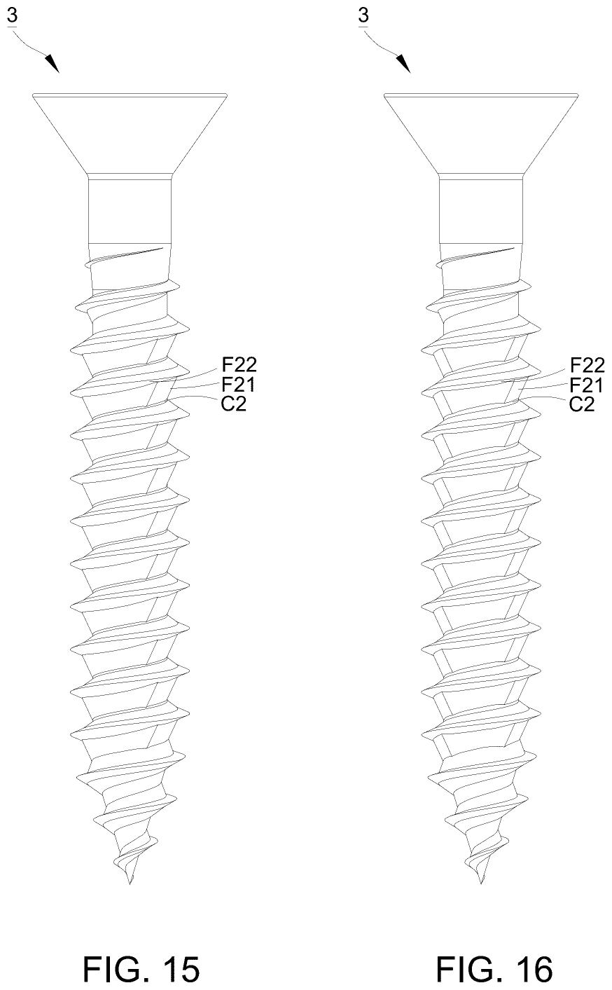

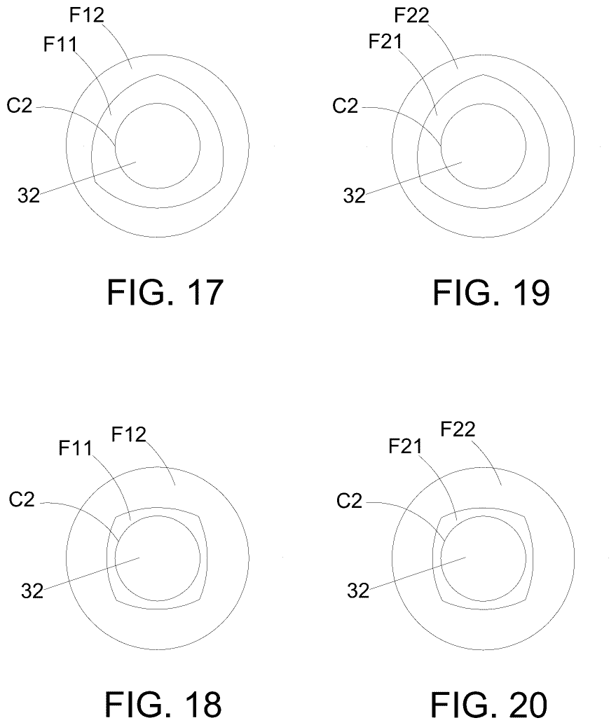

Referring to FIG. 15 and FIG. 16, an eighth preferred embodiment of the versatile fastener 3 is shown. Elements of the eighth preferred embodiment are the same as those of the sixth preferred embodiment. The eighth preferred embodiment is characterised in that the lower connecting section F21 has a non-circular shape, such as a shape with three sides and a shape with four sides. The shape with three sides can be a triangular shape. The shape with four sides can be a quadrilateral shape. Furthermore, the non-circular shape can combine with the structure illustrated by FIG. 11. One combination is shown in FIG. 15 and FIG. 19 wherein the lower connecting section F21 has a three-sided shape. Another combination is shown in FIG. 16 and FIG. 20 wherein the lower connecting section F21 has a four-sided shape. The shapes of the outer periphery C2 of the shank 32 and the lower extension section F22 are not restricted, and herein the circular shape is shown as an example. Accordingly, the non-circular shape allows the thread convolution 331 to cut the workpiece with multiple cutting points, so the drilling efficiency is increased. An efficient accommodation of workpiece chips is attained because of the non-circular shape, which causes the fastener 3 to be firmly engaged with the workpiece. In this regard, the pull-out resistance is augmented to prevent the fastener 3 from being easily pulled out. Meanwhile, the strength of the thread configurations of the thread convolutions 331 is maintained because of the geometric design of the three-sided shape for the four-sided shape. Consequently, the fastener 3 as a whole increases the drilling efficiency, attains a stable fastening effect, and attains a wide use.

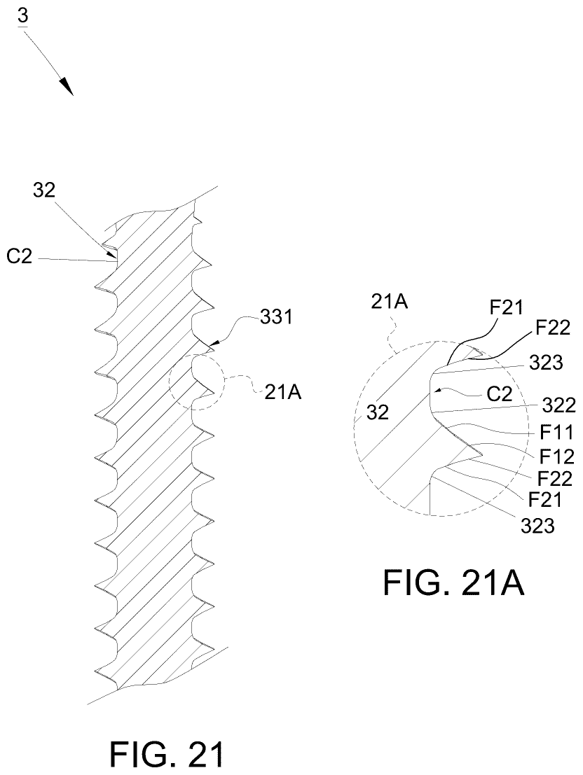

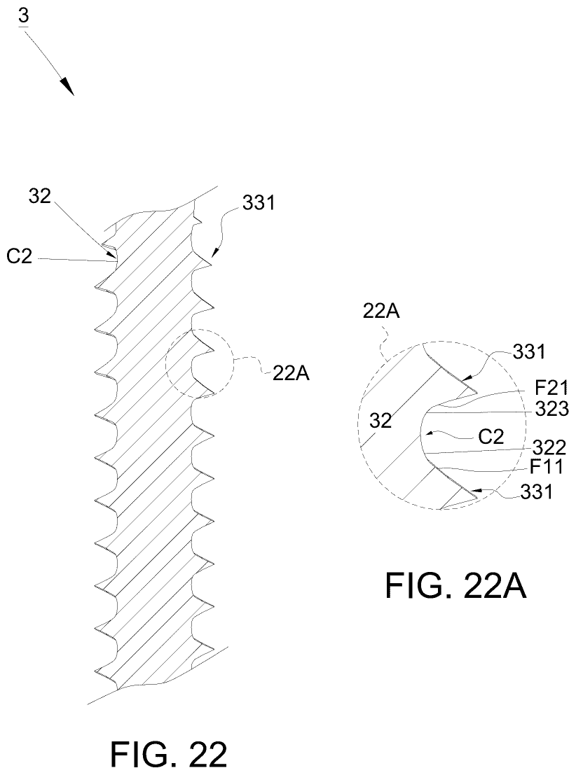

Referring to FIG. 21, a ninth preferred embodiment of the versatile fastener 3 is shown. Elements of the ninth preferred embodiment are the same as those of the first preferred embodiment and herein are not repeated. The ninth preferred embodiment is characterised in that the outer periphery C2 of the shank 32 is exposed to an outside between axially spaced-apart adjacent thread convolutions 331, thereby defining an exposed segment between any two neighboring thread convolutions 331. Each exposed segment of the outer periphery C2 further includes a first transition section 322 and a second transition section 323. The first transition section 322 is connected to the upper connecting section F11 and extended by a length. The second transition section 323 is connected to the lower connecting section F21 and extended by a length. Each of the transition sections 322, 323 has an arcuate surface, such as an inwardly-curved surface illustrated by FIG. 21A. Accordingly, if any two adjacent thread convolutions 331 are discussed, a second transition section 323 is joined to a lower connecting section F21 of one thread convolution 331, and a first transition section 322 is joined to an upper connecting section F11 of the other thread convolution 331. In this regard, the second transition section 323 and the first transition section 322 are spaced apart, as illustrated by FIG. 21 and FIG. 21A. Alternatively, the second transition section 323 joined to one thread convolution 331 is connected to the first transition section 322 joined to the other adjacent thread convolution 331 so that the first transition section 322 and the second transition section 323 merge together, and the exposed segment provides an arcuate surface, such as a whole inwardly-curved surface illustrated by FIG. 22 and FIG. 22A.

In the ninth preferred embodiment, the fastener 3 can be drilled into a workpiece, such as wood, plastic, and rubber. The formation of the first transition section 322 and the second transition section 323 plays a role in the extension of the upper connecting section F11 and the extension of the lower connecting section F21. Both transition sections 322, 323 cooperate with the dual-section flank structure of each thread convolution 331 to increase the engagement with the workpiece, thereby increasing the vibration resistance and accommodating enough workpiece chips to attain an anti-loosening effect. Consequently, the fastener 3 as a whole increases the drilling efficiency, attains a stable fastening effect, and attains a wide use.

To sum up, this invention takes advantage of three dual-section flank structures provided with respective thread shapes to constitute a versatile fastener, the thread convolutions of which can subject different workpieces to an efficient cutting operation according to different material properties, thereby fastening the fastener to the workpieces made of different materials firmly. The use of the fastener also augments the cutting efficiency to reduce the drilling resistance and prevent the fastener from being easily pulled out, thereby attaining a stable fastening effect.

While the embodiments are shown and described above, it is understood that further variants and modifications may be made without departing from the scope of this invention.

What is claimed is:

1. A versatile fastener comprising:
a head;
a shank extending outwards from said head, wherein an outer periphery of said shank defines a central axis and includes a drill portion opposite to said head; and
a plurality of thread convolutions spirally disposed around said outer periphery of said shank;
wherein said plurality of thread convolutions include a first plurality of thread convolutions, a second plurality of thread convolutions, and a third plurality of thread convolutions, said outer periphery of said shank being divided into a plurality of regions according to spiral convolutions of said first plurality of thread convolutions, said second plurality of thread convolutions, and said third plurality of thread convolutions, each of said thread convolutions including an upper flank facing toward said head, a lower flank opposite to said upper flank, and a crest defined along a junction of said upper flank and said lower flank, a baseline being defined by passing through said crest and perpendicular to said central axis, said upper flank including an upper connecting section joined to said outer periphery of said shank and an upper extension section connected to said upper connecting section and extended to said crest, said lower flank including a lower connecting section joined to said outer periphery of said shank and a lower extension section connected to said lower connecting section and extended to said crest, a first upper included angle being defined between said upper connecting section and said baseline, a first lower included angle being defined between said lower connecting section and said baseline, a second upper included angle being defined between said upper extension section and said baseline, a second lower included angle being defined between said lower extension section and said baseline, the sum of said first upper included angle and said first lower included angle being defined as a first angle, the sum of said second upper included angle and said second lower included angle being defined as a second angle, said first angle being different from said second angle, and said first plurality of thread convolutions thereby being in the form of a first dual-section flank structure, said second plurality of thread convolutions thereby being in the form of a second dual-section flank structure, and said third plurality of thread convolutions thereby being in the form of a third dual-section flank structure;
wherein respective first upper included angles of said thread convolutions located in at least two regions of said regions are different from each other, respective first lower included angles of said thread convolutions located in at least two regions of said regions being different from each other, respective second upper included angles of said thread convolutions located in at least two regions of said regions being different from each other, respective second lower included angles of said thread convolutions located in at least two regions of said regions being different from each other, and said first plurality of thread convolutions, said second plurality of thread convolutions, and said third plurality of thread convolutions thereby having respective thread shapes while spiraling around said outer periphery of said shank.

2. The fastener according to claim 1, wherein a thread unit is defined when said thread convolutions are spirally disposed around said outer periphery of said shank in a single and continuous convoluting manner.

3. The fastener according to claim 1, wherein said respective first upper included angles of said thread convolutions located in all of said regions are different from each other, said respective first lower included angles of said thread convolutions located in all of said regions are different from each other, said respective second upper included angles of said thread convolutions located in all of said regions are different from each other, and said respective second lower included angles of said thread convolutions located in all of said regions are different from each other, said respective thread shapes of said first plurality of thread convolutions, said second plurality of thread convolutions, and said third plurality of thread convolutions thereby being different from each other while spiraling around said outer periphery of said shank.

4. The fastener according to claim 1, wherein said first upper included angle is equal to said first lower included angle in any one region of said regions.

5. The fastener according to claim 1, wherein said first upper included angle is different from said first lower included angle in any one region of said regions.

6. The fastener according to claim 1, wherein said second upper included angle is equal to said second lower included angle in any one region of said regions.

7. The fastener according to claim 1, wherein said second upper included angle is different from said second lower included angle in any one region of said regions.

8. The fastener according to claim 2, wherein a maximum thread diameter is defined by said thread unit, and an outer diameter is defined by said outer periphery of said shank, the value of said maximum thread diameter being at least 1.6 times the value of said outer diameter.

9. The fastener according to claim 1, wherein said outer periphery of said shank has a non-circular shape.

10. The fastener according to claim 1, wherein each of said thread convolutions forms a first upper junction, a second upper junction, a first lower junction, and a second lower junction, said first upper junction being a place where said upper connecting section and said outer periphery of said shank meet, said second upper junction being a place where said upper connecting section and said upper extension section meet, said first lower junction being a place where said lower connecting section and said outer periphery of said shank meet, said second lower junction being a place where said lower connecting section and said lower extension section meet, a first reference line being defined between said first upper junction and said first lower junction and perpendicular to said baseline, a second reference line being defined by passing through said second upper junction and said second lower junction and perpendicular to said baseline, a thread height being defined as a vertical distance from said first reference line to said crest, a first height being defined as a vertical distance from said first reference line to said second reference line, the value of said first height being ⅓˜½ times the value of said thread height.

11. The fastener according to claim 1, wherein said first angle ranges from 40 degrees to 60 degrees, and said second angle ranges from 25 degrees to 50 degrees.

12. The fastener according to claim 1, wherein said first angle exceeds 90 degrees.

13. The fastener according to claim 12, wherein said first angle ranges from 100 degrees to 110 degrees.

14. The fastener according to claim 12, wherein said upper connecting section has a non-circular shape.

15. The fastener according to claim 12, wherein said lower connecting section has a non-circular shape.

16. The fastener according to claim 1, wherein at least two thread convolutions of said thread convolutions are spirally disposed around said drill portion.

17. The fastener according to claim 1, wherein said outer periphery of said shank is exposed to an outside between axially spaced-apart adjacent thread convolutions and includes a first transition section connected to said upper connecting section and a second transition section connected to said lower connecting section, with said first transition section having an arcuate surface, and said second transition section having an arcuate surface.
